(19) United States
(12) Patent Application Publication
(10) Pub. No.: US 2003/0154230 A1
(43) Pub. Date: Aug. 14, 2003

(54) Electronic device and camera

(76) Inventors: Yasuhiro Harada, Kanagawa (JP); Masanori Ohtsuka, Kanagawa (JP)

Correspondence Address: ROBIN BLECKER & DALEY, 2ND FLOOR, 330 MADISON AVENUE, NEW YORK, NY, 10017, US

(21) Appl. No.: 10/358,677

(22) Filed: Feb. 5, 2003

(30) Foreign Application Priority Data
Feb. 8, 2002 (JP) 032036/2002

(51) Int. Cl. G06G 7/00

(52) U.S. Cl. 708/801

(57) ABSTRACT

The present invention relates to an electronic device comprising an arithmetic circuit for controlling the electronic device and a voltage detecting circuit for detecting that a power source voltage supplied to the arithmetic circuit drops below a predetermined voltage value guaranteeing an operation of the arithmetic circuit at a predetermined operating frequency. The electronic device is provided with an operating frequency changeover circuit for changing the operating frequency of the arithmetic circuit to one of a plurality of frequencies and the operating frequency changeover circuit changes the operating frequency of the arithmetic circuit to a lower frequency if it is detected that the power source voltage drops below the predetermined voltage value. This configuration enables provision of an electronic device such as a camera without a complicated circuitry, being free from a runaway condition of an arithmetic circuit such as a microcomputer at an occurrence of a power supply interruption caused by shock or vibration, so that a user has no unnatural operating feel at the power supply interruption.

### BACKGROUND OF THE INVENTION

1. Field of the Invention

The present invention relates to an improvement of an electronic device or a camera that changes an operating frequency of a microcomputer, which is an arithmetic circuit, according to a voltage of a power supply.

2. Related Background Art

In a portable device that drives various control circuits mounted thereon using power supplied from a mounted battery, severe vibration or shock applied to the portable device during use may cause a loose connection between the mounted battery and a battery section and an interruption of supplying power to an incorporated microcomputer (hereinafter, referred to as power supply interruption).

Therefore, this type of portable device prevents runaway caused by the power supply interruption by incorporating a reset circuit for initializing the microcomputer if power (voltage) supplied into a power supply circuit of the microcomputer drops below a predetermined value. In addition, with connecting a backup capacitor to a power supply circuit of the microcomputer, the voltage supplied to the microcomputer is prevented from being less than an operation guaranteeing voltage of the microcomputer at an occurrence of a power supply interruption if the interruption terminates within a predetermined period of time.

In the former conventional example of a system preventing runaway of the microcomputer by detecting a power supply interruption, the microcomputer is initialized at every power supply interruption and therefore the system is very unavailable. In the latter conventional example, the device must contain a large-sized capacitor and therefore the portable device need be of a large size.

Contrary to them, Japanese Patent Application Laid-Open No. 8-32026 discloses a control unit for controlling a microcomputer to interrupt a program operation temporarily instead of re-executing the program operation from an initial state so as to prevent a reset occurrence at every power supply interruption if the power supply recovers from the power supply interruption in a short time. Furthermore, Japanese Patent Application Laid-Open No. 7-114401 discloses a control unit enabling measures against runaway to be taken at a power supply interruption without a need for a complicated circuitry by setting a higher voltage than a reset voltage of a microcomputer as an operation guaranteeing voltage of the microcomputer so as to secure a period of time for a voltage drop from the time when the voltage supplied to the microcomputer drops below the operation guaranteeing voltage to the time when it reaches the reset voltage.

In the above control unit in Japanese Patent Application Laid-Open No. 8-32026, however, the power supply interruption stops the operation in execution though a reset does not occur at every power supply interruption and therefore a device required to continue a series of operations such as, for example, a light measurement, a distance measurement, and an exposure like a camera cannot keep the continuity of the operations disadvantageously.

Furthermore, Japanese Patent Application laid-Open No. 5-137393 discloses a control unit enabling a stable system operation to continue even at a low voltage by changing a voltage control method for driving an actuator according to a decrease of a power source voltage. This control unit, however, has to change a drive circuit for the actuator and a structure of its driving method so that the actuator can be driven even if a supplied voltage is lower than usual because of a fixed operating frequency of a microcomputer performing various controls. Therefore, there is a need for a circuit arrangement enabling the drive circuit to drive the actuator even if the voltage is lower than the normal voltage and further a need for preparing control parameters for each control method, thereby complicating the entire system configuration and the control method.

### SUMMARY OF THE INVENTION

Therefore it is an object of the present invention to provide an electronic device comprising an arithmetic circuit for controlling the electronic device and a voltage detecting circuit for detecting that a power source voltage supplied to the arithmetic circuit drops below a predetermined voltage value guaranteeing an operation of the arithmetic circuit at a predetermined operating frequency, wherein the electronic device is provided with an operating frequency changeover circuit for changing the operating frequency of the arithmetic circuit to one of a plurality of frequencies and the arithmetic circuit causes the operating frequency changeover circuit to change the operating frequency of the arithmetic circuit to a lower frequency if it is detected that the power source voltage drops below the predetermined voltage value. This configuration enables provision of an electronic device such as a camera without a complicated circuitry, being free from a runaway condition of an arithmetic circuit such as a microcomputer at an occurrence of a power supply interruption caused by shock or vibration, so that a user has no unnatural operating feel at the power supply interruption.

Other objects and advantages besides those discussed above shall be apparent to those skilled in the art from the description of a preferred embodiment of the invention that follows. In the description, reference is made to accompanying drawings, which form a part hereof, and which illustrate an example of the invention. Such example, however, is not exhaustive of the various embodiments of the invention, and therefore reference is made to the claims, which follow the description for determining the scope of the invention.

### BRIEF DESCRIPTION OF THE DRAWINGS

FIG. 1 is a block diagram showing a circuitry of a camera control unit according to a first embodiment of the present invention;

FIG. 2 is a diagram showing a relation between an operating frequency and an operating voltage of a microcomputer according to the first embodiment of the present invention;

FIG. 3 is a timing chart showing a power source voltage and a camera control signal according to the first embodiment of the present invention;

FIG. 4 is also a timing chart showing a power source voltage and a camera control signal according to the first embodiment of the present invention;

FIG. 5 is a flowchart showing a camera control operation at a time of occurring an interruption process caused by a power supply interruption, according to the first embodiment of the present invention;

FIG. 6 is a flowchart showing a camera control operation at a time of occurring a reset process caused by a power supply interruption, according to the first embodiment of the present invention;

FIG. 7 is a block diagram showing a circuitry of a camera control unit according to a second embodiment of the present invention; and

FIG. 8 is a flowchart showing a camera control operation at a time of occurring an interruption process caused by a power supply interruption, according to the second embodiment of the present invention.

### DESCRIPTION OF THE PREFERRED EMBODIMENTS

The preferred embodiments of the present invention will now be described in detail hereinafter with reference to the accompanying drawings.

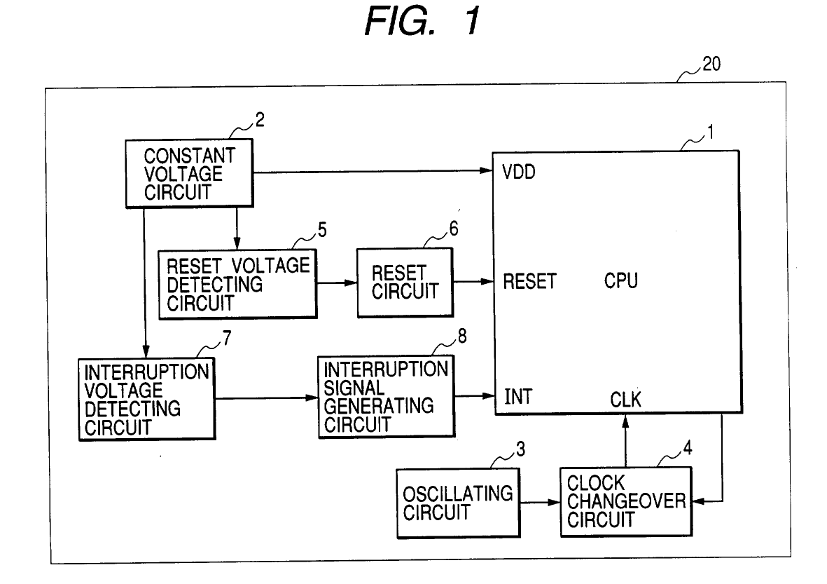

Referring to FIG. 1, there is shown a block diagram of an electric configuration of a camera control unit and the main part according to a first embodiment of the present invention.

In this diagram, there is shown a one-chip microcomputer 1, which is control means for controlling various operations of a camera 20, comprising a CPU, a mask ROM, a flash memory, a RAM, and a peripheral circuit, which are not shown. The flash memory and the mask ROM store a control program and control data for controlling various camera operations such as a light measurement, a distance measurement, feeding, and stroboscope charging, which are read by the CPU so that their functions are executed. A constant voltage circuit 2 converts a battery voltage to a predetermined voltage and then supplies it to the CPU and the above circuits. An oscillating circuit 3, which comprises an oscillator not shown, supplies a clock signal having a predetermined frequency such as, for example, 16 MHz to the microcomputer via a clock changeover circuit 4 described later. The clock changeover circuit 4 changes a frequency of the clock signal supplied to the CPU by multiplying and dividing the clock signal from the oscillating circuit 3 using known multiplier and divider circuits. For example, it is possible to change an operating frequency of the CPU to a high-speed frequency fh=16 MHz or a low-speed frequency fl=4 MHz.

A reset voltage detecting circuit 5 for detecting a power source voltage VDD supplied to the CPU detects that the power source voltage VDD drops below a reset voltage of the CPU and outputs a first detection signal. The term “reset voltage” here is a voltage Vl that guarantees an operation of the CPU at the low-speed frequency fl=4 MHz as the power source voltage VDD. A reset circuit 6 issues a reset signal RESET for a high-to-low level change to a reset terminal of the CPU in response to an input of the first detection signal from the reset voltage detecting circuit 5. An interruption voltage detecting circuit 7 for detecting the power source voltage VDD supplied to the CPU outputs a second detection signal when detecting that the power source voltage VDD drops below an interruption voltage of the CPU. The term “interruption voltage” here is a voltage Vh that guarantees an operation of the CPU at the high-speed frequency fh=16 MHz. An interruption signal generating circuit 8 issues an interruption signal INT for a high-to-low level change to an interruption terminal of the CPU in response to an input of the second detection signal from the interruption voltage detecting circuit 7.

The following describes a camera control operation at an occurrence of a power supply interruption that is an operation of the main part according to the first embodiment with reference to FIGS. 1 to 3.

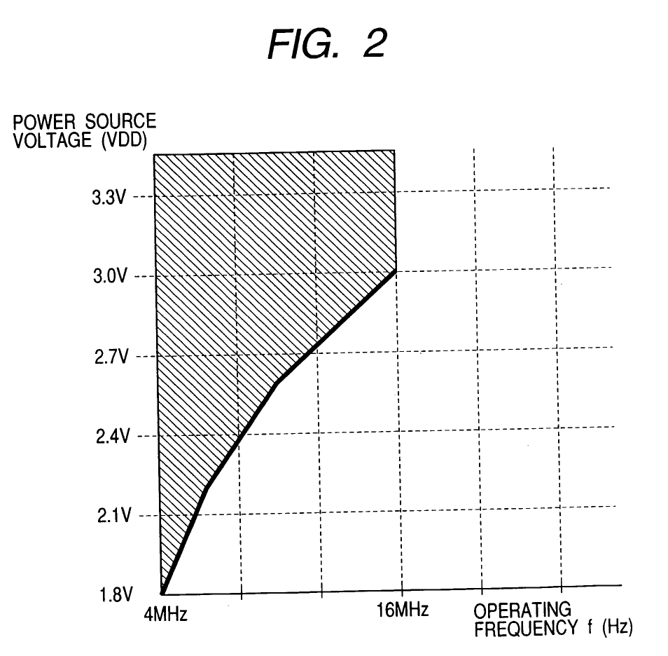

Referring to FIG. 2, there is shown a relation between an operating frequency f and a power source voltage VDD of a 3.3V camera control microcomputer using a battery as a power supply.

A shaded area in FIG. 2 is an area where the CPU in the microcomputer can operate normally. There is dependence between the power source voltage VDD and the operating frequency f of the CPU, by which lowering the operating frequency f decreases the power source voltage VDD at which the CPU is operable.

For example, in the 3.3V CPU shown in FIG. 2, the operation guaranteeing voltage Vh is 3.0V in the operation at 16 MHz, which is a high-speed operation. Therefore, if VDD is within the range of 3.0V to 4.0V, the operation at 16 MHz is guaranteed. The lowest operation guaranteeing voltage Vl is 1.8V in the operation at 4 MHz, which is a low-speed operation. In the normal operation of the camera, the operation at 16 MHz is performed to realize a high-speed operation of the camera.

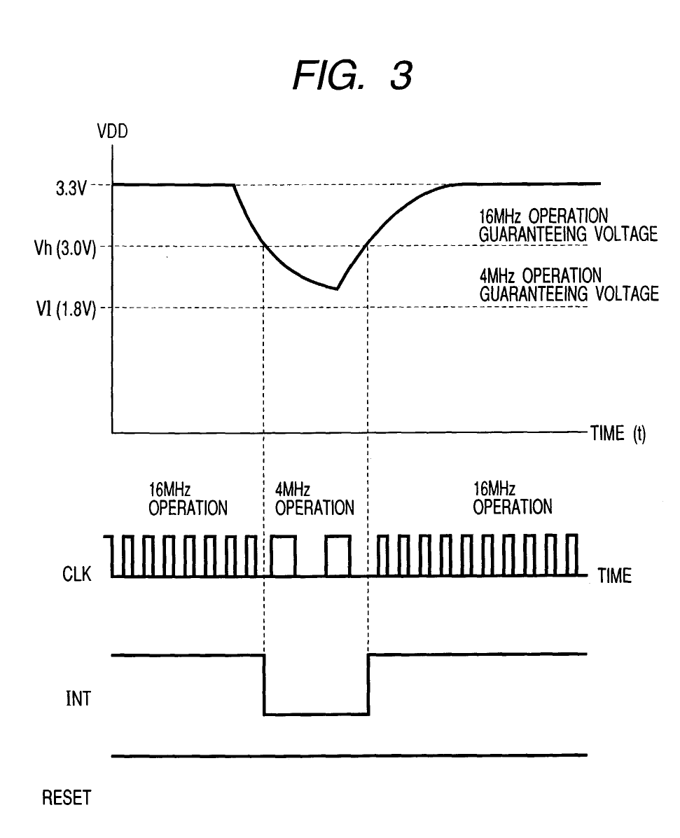

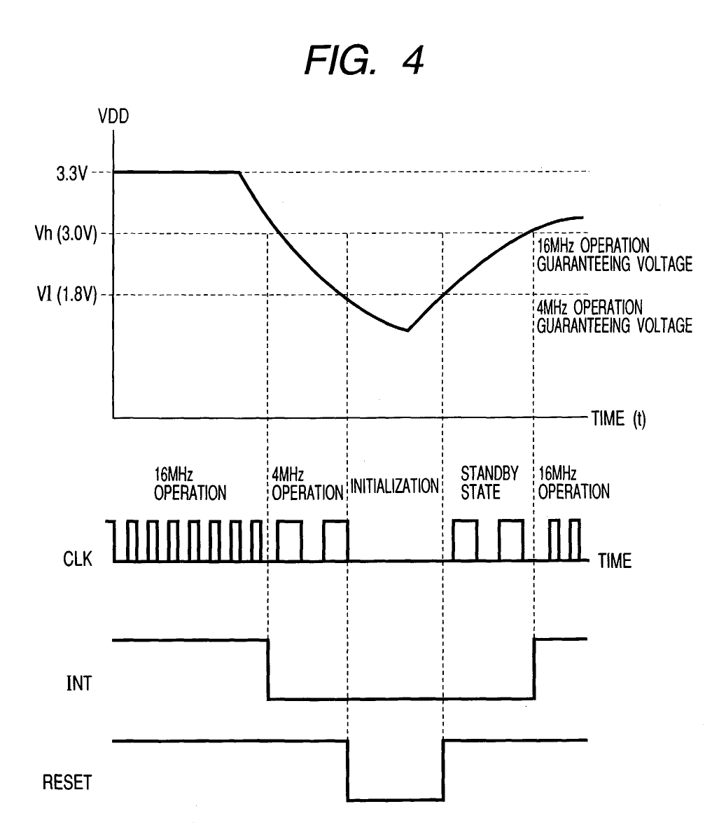

Referring to FIG. 3 and FIG. 4, there are shown diagrams illustrating an output waveform of the power source voltage VDD at an occurrence of a power supply interruption, a clock signal CLK supplied to the CPU, an interruption signal INT, and a reset signal RESET.

As shown in FIG. 3, if the power source voltage VDD of the CPU drops below the operation guaranteeing voltage Vh=3.0V during camera operation, the interruption voltage detecting circuit 7 detects that the power source voltage VDD drops below the interruption voltage 3.0V and the interruption signal generating circuit 8 inputs an interruption signal (a falling edge signal) for a high-to-low level change to the INT, by which an interruption occurs at the CPU.

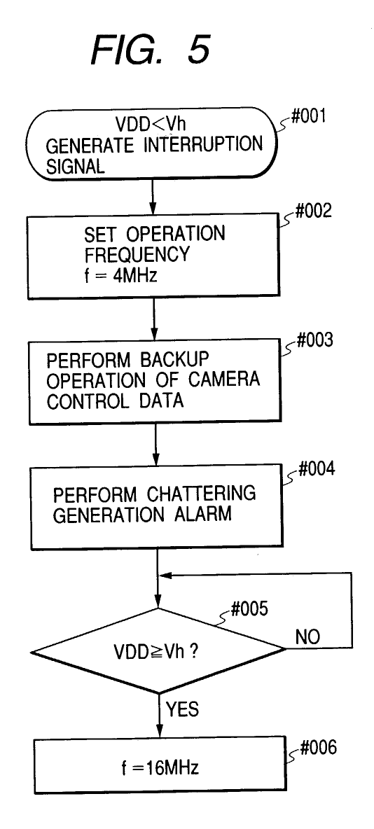

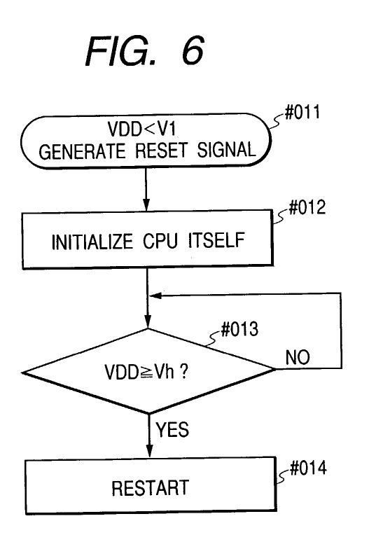

The operation sequence at an occurrence of the interruption will now be described with reference to a flowchart in FIG. 5 and FIG. 6. If an interruption is caused by a decrease of the power source voltage VDD due to a power supply interruption resulting from a shock or the like in step #001, the CPU changes the operating frequency from the high-speed frequency 16 MHz to the low-speed frequency 4 MHz by using the clock changeover circuit 4 in the next step #002. While this change causes the operation speed to be one-fourth thereof, the operation guaranteeing voltage of the CPU drops to 1.8V. Subsequently, the control progresses to step #003 for a backup operation of camera control data. Specifically, control data such as an image-taking mode and a lens position of a lens barrel temporarily stored in a volatile memory during operation is stored into a nonvolatile memory such as a flash memory. This enables the camera to resume the operation without giving a photographer any unnatural operating feel which may be caused by an image-taking mode different from one that had been used before the power supply interruption, even where the CPU is initialized since the power source voltage VDD drops below Vl (=1.8V) (See FIG. 3 and FIG. 4).

In the next step #004, an alarm is given to inform the photographer of an occurrence of the power supply interruption (chattering generation) by using display means not shown such as an external LCD for a camera or sound generation means such as a buzzer. This enables the photographer to recognize that, if a camera reset operation occurs since the power source voltage VDD drops below 1.8V as shown in FIG. 4, it is caused by a power supply interruption due to a shock.

In the next step #005, the camera is put in a standby state (the above memory backup and chattering generation alarm operations are performed) as shown in FIG. 3 and the CPU checks the power source voltage VDD. If the power source voltage VDD resumes Vh or a higher voltage, the CPU causes the clock changeover circuit to change the operating frequency to 16 MHz as shown in FIG. 3 (step #006). If the power source voltage VDD drops further below the operation guaranteeing voltage Vl as shown in FIG. 4, the reset voltage detecting circuit 5 detects that the power source voltage VDD is lower than the reset voltage 1.8V and the reset circuit 6 inputs a reset signal to RESET (step #011). In the next step #012, the CPU initializes itself. In the next step #013, the CPU checks the power source voltage VDD and puts the camera in a standby state until the power source voltage VDD rises to Vh or higher where the highspeed operation is guaranteed. When the power source voltage rises to Vh or higher, the CPU restarts the camera (step #014).

According to the first embodiment in the above, if the power source voltage VDD drops below the operation guaranteeing voltage Vh (=3.0V) in the operation at 16 MHz for the normal operation of the camera, the CPU is not initialized, but the operating frequency is changed to 4 MHz with an interruption, thereby preventing the operation from being initialized immediately by a power supply interruption. In addition, the chattering generation alarm, the memory backup operation, and the like can be performed during a period of time after the interruption occurrence and before the power source voltage drops to the minimum operation guaranteeing voltage Vl (=1.8V) in the operation at 4 MHz where the initialization is necessary, thereby enabling the photographer to control the camera without having any unnatural operating feel at the chattering generation.

Furthermore, if the microcomputer contains a plurality of memories having different operating voltages, a stable operation is achieved at a still lower voltage by executing a control program after the change to 4 MHz on a memory operable at the still lower voltage. For example, if the microcomputer has a flash memory and a mask ROM as executable memories, a stable operation is achieved at a still lower voltage by using the mask ROM. Therefore, if the operation guaranteeing voltage of the mask ROM is lower than the operation guaranteeing voltage Vl (=1.8V) of the CPU, the operation at 4 MHz is more stabilized by executing the program after the change to 4 MHz on the mask ROM. In other words, the minimum operation guaranteeing voltage Vl of the microcomputer can be set to a value lower than 1.8V.

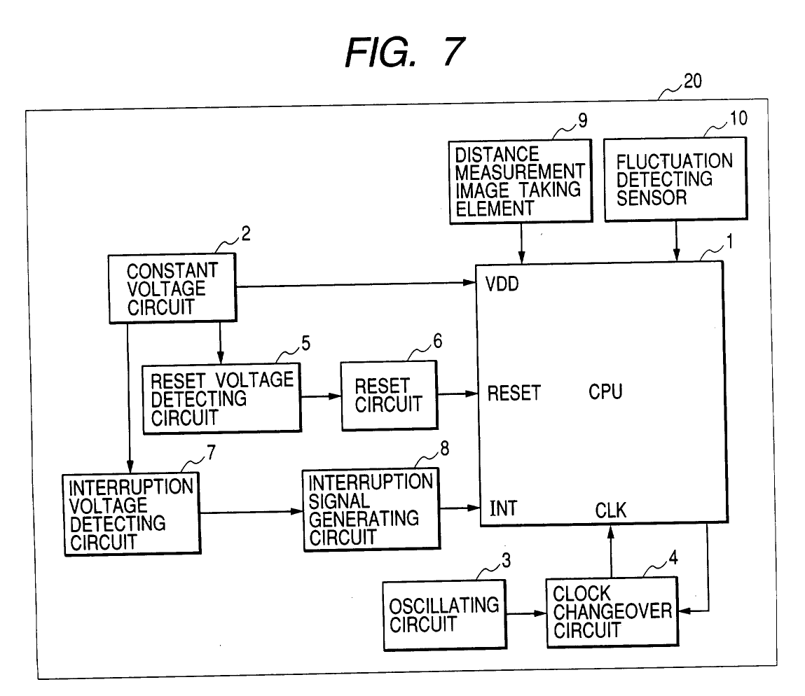

Referring to FIG. 7, there is shown a block diagram illustrating an electric configuration of a camera control unit and the main part according to a second embodiment of the present invention, where the same parts as those in FIG. 1 are designated by corresponding reference numerals and their description will be omitted here. In FIG. 7, there are shown a distance measurement image taking element 9 and a fluctuation detecting sensor 10 for detecting camera vibrations.

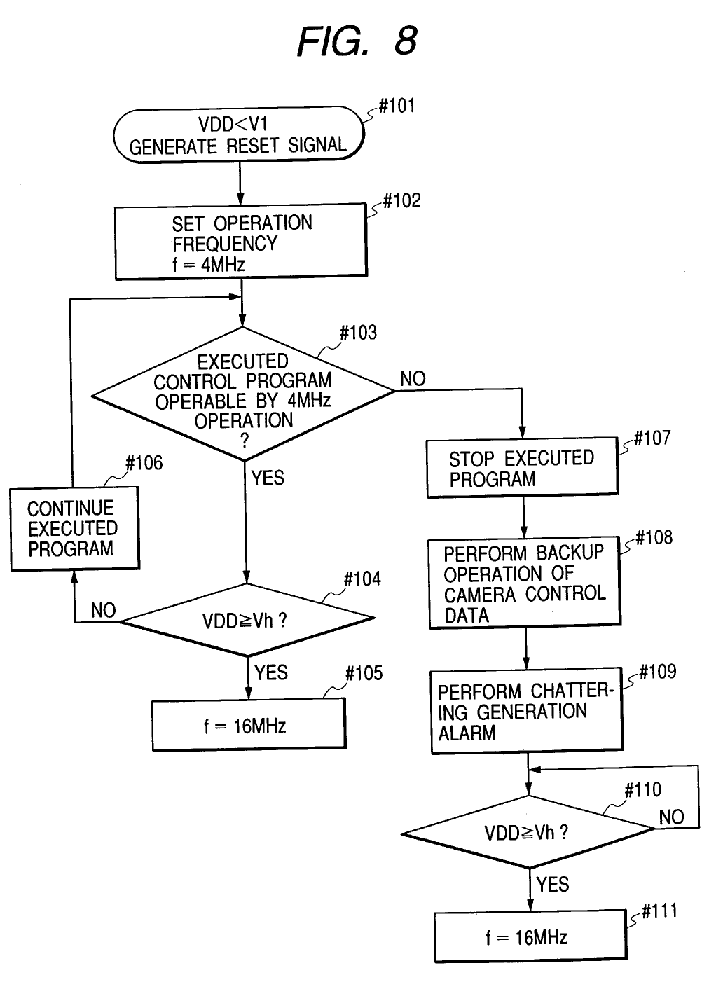

The following describes a camera control operation at an occurrence of a power supply interruption, which is the operation of the main part according to the second embodiment, with reference to a flowchart shown in FIG. 8.

If it is detected that the power source voltage VDD drops below the operation guaranteeing voltage Vh due to a power supply interruption resulting from a shock or the like and an interruption occurs in step #101, the CPU changes the operating frequency f of the CPU from the high-speed frequency fh=16 MHz to the low-speed frequency fl=4 MHz by using the clock changeover circuit 4 in the next step #102. In the next step #103, it is determined whether the currently active camera control program is operable also at 4 MHz instead of the maximum speed 16 MHz.

The term “camera control operation inoperable at 16 MHz” here is a distance measurement operation using the distance measurement image taking element and a camera vibration detecting operation using the fluctuation detecting sensor, for example. In the distance measurement operation and the camera vibration detecting operation, there is a need for performing an analog-to-digital conversion and an arithmetic operation of mass data at a high speed. Therefore, these processes require a period of time four times as long as the 16 MHz operation as a result of the clock changeover from 16 MHz to 4 MHz. In the distance measurement operation, the distance measurement need be completed within an allowable release time lag and processing time four times as long as the 16 MHz operation is not allowable. Furthermore, the camera vibration detecting operation need be controlled in real time as far as possible. An increase of a time lag caused by the analog-to-digital conversion and the arithmetic operation significantly deteriorates an accuracy of the camera vibration detecting operation, however. Therefore, the operation at 4 MHz is not allowable.

If it is determined that the camera operation in execution is operable at 4 MHz in the above step #103, in other words, if the camera operation in execution is other than the distance measurement operation and the camera vibration detecting operation, the control progresses to step #104. In the step #104, the CPU checks the power source voltage VDD. If the power source voltage VDD resumes Vh or a higher voltage, the CPU causes the clock changeover circuit to change the operating frequency to 16 MHz. If the power source voltage VDD does not resume Vh or a higher voltage, the CPU continues the camera operation in execution at 4 MHz (step #106). Then, if the camera control program in execution is completed in the step #106, the control returns to the step #103 to determine again whether the operation program to be executed subsequently is operable.

If it is determined that the camera operation in execution is inoperable at 4 MHz this time in the above step #103, the control progresses to step #107 to stop the camera control operation in execution and then to step #108. In the step #108, a backup operation is performed for the camera control data. Subsequently, the control progresses to step #109 to give an alarm to inform the photographer of an occurrence of a power supply interruption by using display means not shown such as an external LCD for a camera or the like or sound generation means such as a buzzer. In the next step #118, the camera is put in a standby state; if the power source voltage VDD resumes a voltage of Vh or higher, the CPU causes the operating frequency to be changed to 16 MHz to resume the operation (step #111). On the other hand, if the power source voltage VDD drops further below Vl, the CPU is initialized in response to a reset signal from the reset circuit 6 and the camera is put in a standby state until the power source voltage VDD rises to Vh or higher where the high-speed operation is guaranteed, thereafter the camera is restarted when the power source voltage VDD becomes Vh or higher as shown in FIG. 6.

According to the second embodiment, if the power source voltage drops below the operation guaranteeing voltage Vh at the 16 MHz operation for the normal operation of the camera, the operating frequency is changed over to 4 MHz with an interruption instead of a reset operation, and furthermore if the control program in execution is operable also at 4 MHz, the operation is continued, by which the operation is not initialized even if a power supply interruption occurs and the camera operation can be continued at a low voltage.

Furthermore, though the operating frequency is changed immediately from 16 MHz to 4 MHz after the occurrence of the interruption, a capacitor is arranged between the power source voltage VDD and a ground and the interruption voltage is set to “Vh′=Vh+ΔV” higher than Vh, thereby enabling the camera operation requiring the 16 MHz operation to be completed during a drop from Vh′ to Vh and therefore preventing the camera operation from being stopped in a half-finished stage. Specifically, supposing that I represents consumed current needed for the camera operation requiring the 16 MHz operation (for example, a distance measurement operation) and t′ represents time needed for the operation, the capacitance C of the capacitor and the interruption voltage Vh′ are determined so as to satisfy the following:

C=I/(ΔV·t′)

by which the operating frequency can be changed to 4 MHz after the distance measurement operation is terminated even if an interruption at a lower power source voltage occurs during the distance measurement operation.

While the camera operation inoperable at 4 MHz is the distance measurement operation or the camera vibration detecting operation in the above second embodiment, it is not limited to them, but other camera operations may be determined to be inoperable at 4 MHz according to a performance required for the camera.

In addition, while the present invention has been described by giving examples in which the invention is applied to a camera in the above first and second embodiments, the present invention is not limited to them, but the invention is applicable to an electronic device other than a camera only if the electronic device controls operations with a microcomputer.

What is claimed is:

1. An electronic device, comprising:
an arithmetic circuit for controlling said electronic device;
an operating frequency changeover circuit for changing an operating frequency of said arithmetic circuit to one of a plurality of frequencies; and
a voltage detecting circuit for detecting that a power source voltage supplied to said arithmetic circuit drops below a predetermined voltage value guaranteeing an operation of said arithmetic circuit at a predetermined operating frequency,
wherein said arithmetic circuit causes said operating frequency changeover circuit to change the operating frequency of said arithmetic circuit to a frequency lower than the predetermined frequency if it is detected that the power source voltage drops below the predetermined voltage value.

2. An electronic device, comprising:
an arithmetic circuit for controlling said electronic device;
a first voltage detecting circuit for detecting that a power source voltage supplied to said arithmetic circuit drops below a first voltage value guaranteeing an operation of said arithmetic circuit at a first operating frequency;
a second voltage detecting circuit for detecting that said power source voltage drops below a second voltage value guaranteeing an operation of said arithmetic circuit at a second operating frequency higher than said first operating frequency;
an operating frequency changeover circuit for changing the operating frequency of said arithmetic circuit; and
a reset circuit for resetting a program operation of said arithmetic circuit,
wherein, if it is detected that said power source voltage drops below said second voltage value, said arithmetic circuit causes said operating frequency changeover circuit to change the operating frequency of said arithmetic circuit from said second operating frequency to said first operating frequency, and if it is detected that said power source voltage drops below said first voltage value, said reset circuit for resetting the program operation of said arithmetic circuit.

3. The device according to claim 2, further comprising an interruption signal generating circuit for generating an interruption signal causing said arithmetic circuit to perform an interrupting operation if it is detected that said power source voltage drops below said second voltage value, wherein said arithmetic circuit causes said operating frequency changeover circuit to change the operating frequency of said arithmetic circuit from said second operating frequency to said first operating frequency if said interruption signal is generated.

4. The device according to claim 3, wherein said arithmetic circuit causes said operating frequency changeover circuit to change the operating frequency of said arithmetic circuit from said second operating frequency to said first operating frequency and wherein said arithmetic circuit executes a control operation operable at said first operating frequency as said interrupting operation.

5. The device according to claim 4, wherein said arithmetic circuit performs a control data protecting operation, as said interrupting operation, necessary for enabling continuation of the control operation before said power source voltage drops below said second voltage value when said power source voltage resumes said second voltage value.

6. The device according to claim 4, wherein said arithmetic circuit gives an alarm to inform a user that said power source voltage drops below said second voltage value as said interrupting operation.

7. An electronic device, comprising:
an arithmetic circuit for controlling said electronic device;
a first voltage detecting circuit for detecting that a power source voltage supplied to said arithmetic circuit drops below a first voltage value guaranteeing an operation of said arithmetic circuit at a first operating frequency;
a second voltage detecting circuit for detecting that said power source voltage drops below a second voltage value guaranteeing an operation of said arithmetic circuit at a second operating frequency higher than said first operating frequency;
an operating frequency changeover circuit for changing the operating frequency of said arithmetic circuit; and
a determination circuit for determining whether a processing operation that cannot be continued at said first operating frequency is being performed when the operating frequency of said arithmetic circuit is changed to said first operating frequency;
wherein, if it is detected that said power source voltage drops below said second voltage value, said arithmetic circuit causes said operating frequency changeover circuit to change the operating frequency of said arithmetic circuit from said second operating frequency to said first operating frequency, and if said determination circuit determines that the processing operation that cannot be continued at said first operating frequency is being performed, said arithmetic circuit stops the processing operation being executed.

8. The device according to claim 7, wherein the processing operation that cannot be continued at said first operating frequency is a distance measurement operation or a vibration control operation.

9. The device according to claim 1, wherein said electronic device is a camera.

10. The device according to claim 2, wherein said electronic device is a camera.

11. The device according to claim 7, wherein said electronic device is a camera.
